(19) United States
(12) Patent Application Publication
(10) Pub. No.: US 2007/0030802 A1
(43) Pub. Date: Feb. 8, 2007

(54) ENABLING NON REAL-TIME COMMUNICATION ENABLED DEVICES TO PARTICIPATE IN REAL TIME COMMUNICATION SCENARIOS

(75) Inventor: Richard A. Wilson JR., Temecula, CA (US)

Correspondence Address: CANON U.S.A. INC. INTELLECTUAL PROPERTY DIVISION, 15975 ALTON PARKWAY, IRVINE, CA, 92618-3731, US

(73) Assignee: CANON DEVELOPMENT AMERICAS, INC., Irvine, CA (US)

(21) Appl. No.: 11/461,078

(22) Filed: Jul. 31, 2006

Related U.S. Application Data
(60) Provisional application No. 60/705,785, filed on Aug. 5, 2005.

(51) Int. Cl. H04L 12/26; H04L 12/56

(52) U.S. Cl. 370/229; 370/400

(57) ABSTRACT

A system and method for allowing non-real time communication protocol enabled devices to participate in real-time communication protocol scenarios, comprising: discovering at least one non-real time communication protocol enabled device; logging on to at least one real-time communication server; assigning a unique real-time communication protocol identity to the at least one non-real time communication protocol enabled device; assigning a service proxy for the at least one non-real time communication protocol enabled device; and adding the unique real-time communication protocol identity to the at least one real-time communication server.

### BACKGROUND OF THE INVENTION

1. Field of the Invention

The present invention relates to enabling non real-time communication protocol enabled devices to participate in real-time communication protocol scenarios.

2. Description of the Related Art

Data networks have become commonplace for interconnecting various elements such as personal computers, computer peripherals (i.e., printer), servers, etc. The elements making up a data network have traditionally been connected via cables and wires, while more recently the connection has been accomplished wirelessly. Data networks are usually either public networks, such as the Internet, or private, local networks. Typical forms of communications between the elements on the data network include transfer of commands and data, file transfers, and e-mail messages.

Recently, a significant number of people have begun to communicate over data networks using real-time interactive communication protocols. In a real-time communications environment, a user is able to, among other things, communicate with friends and/or co-workers in real-time, receive real-time up-to-date news, or receive notifications from a vendor's web site based on the user's pre-defined settings. It is features such as this that have helped increase the popularity of real-time communication protocols. One aspect of real-time communication protocols that have made them popular is their use of a presence capability. Presence capability allows users who are logged into a particular real-time chat application to know when other parties are available. Presence information typically manifests itself as the “buddy list” or contacts list of a real-time communication protocol.

Until recently, real-time communication protocols were only being used for communication between users. One early drawback to the implementation of real-time communication protocols was that they only made use of presence information relating to users. In other words, early real-time communication protocols only supported user-to-user communication. As a result, the communication, e.g., the transfer of text messages, photos, etc., occurred only between users, where each user was logged into their respective real-time communication protocol.

Recently, the application of real-time communication protocols has begun to encompass communication between users and devices. For example, real-time communication protocols are being used to send commands to and receive data from various devices. The same principals, i.e., use of real-time communication protocol presence capability, that have been used in the user-to-user environment are applicable in the user-to-device environment. In addition, they are also applicable in device-to-device environments, where events on devices could trigger events on other devices.

In order to achieve real-time communication with a device, the device must include some type of real-time communication protocol client. While newer devices may have this feature available, older (i.e., legacy) devices do not, and adding a real-time communication protocol client to these devices may either be difficult or impossible. Thus, individual customers and businesses with these legacy devices who wish make use of the advantages provided by real-time communication protocols will not be able to do. Their only alternative would to replace the legacy devices with real-time communication protocol enabled devices, which in many instances, would not be a cost effective solution.

Given the popularity of real-time communication protocols, what is needed is a method for allowing non real-time communication protocol enabled devices to participate in real-time communication protocol scenarios.

### SUMMARY OF THE INVENTION

The forgoing problem is addressed by a method and system for allowing non-real time communication protocol enabled devices to participate in real-time communication protocol scenarios.

More specifically, the present invention provides a system and method for allowing non-real time communication protocol enabled devices to participate in real-time communication protocol scenarios comprising discovering at least one non-real time communication protocol enabled device, logging onto at least one real-time communication server, assigning a unique real-time communication protocol identity to the at least one non-real time communication protocol enabled device, assigning a service proxy for the at least one non-real time communication protocol enabled device, and adding the unique real-time communication protocol identity to the at least one real-time communication server.

The present invention allows users of non-real time communication protocol enabled devices who wish to take advantage of the capabilities provided by real-time communication protocols to use their devices in real-time communication protocol scenarios, thus avoiding the costs associated with replacing their devices. A more complete understanding of the invention can be obtained by reference to the following detailed description of the preferred embodiment(s) thereof in connection with the attached drawings.

### BRIEF DESCRIPTION OF THE DRAWINGS

FIG. 1 is a representational view of the general configuration of the system of the present invention.

FIG. 2 is a flowchart describing a process of enabling non-real time communication protocol enabled devices to participate in real-time communication protocol scenarios according to the present invention.

FIG. 3 is a flowchart describing a user's process of using a discovered real-time communication protocol enabled device after performing the discovery process of the present invention.

FIG. 4 depicts the architecture of an RTC client according to an embodiment of the present invention.

### DETAILED DESCRIPTION OF THE INVENTION

The invention is described by way of an exemplary embodiment, but it is understood that the description is not intended to limit the invention to this embodiment, and is intended to cover alternatives, equivalents, and modifications such as are included within the scope of the appended claims.

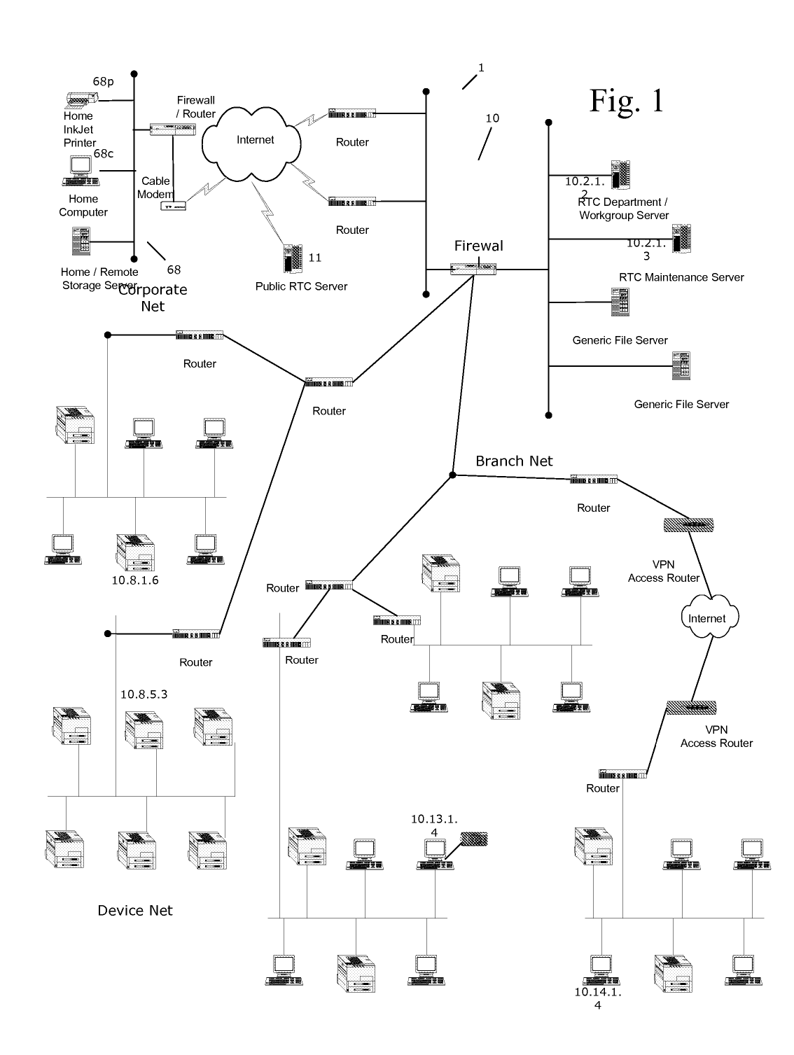

FIG. 1 is a representational view of a system 1 which contains a combination of real-time communication protocol enabled devices and non-real-time communication protocol enabled devices. System 1 includes non-real time communication enabled user devices 10.8.1.6 and 10.8.5.3. These devices as depicted in FIG. 1 are network printers. However, the present invention is not limited to this type of device, and other user devices, such as facsimile machines, storage devices, etc. that would enable practice of the present invention are applicable.

Also included in System 1 are Public RTC Server 11, RTC Department/Workgroup Server 10.2.1.2, and RTC Maintenance Server 10.2.1.3. The purpose and functionality of RTC servers is well known in the art and a detailed description is omitted herein. However, for completeness, a brief discussion of how these RTC servers work within the system of the present invention will be provided.

As is known in the art, users of a particular real-time communication service register their credentials (e.g., username and password) with a server of the real-time communication server, i.e., RTC server. By registering, users are then capable of connecting to and communicating with other users of the real-time communication service. This connection and communication process is accomplished by users of the real-time communication service adding other users to their buddy list, thus enabling users to know when the other party is available. In the present invention, not only do users register with an RTC server, but the real-time communication protocol enabled devices also register with the RTC server. Thus, the RTC server allows a user to determine if a particular real-time communication protocol enabled device is present. And, if the real-time communication protocol enabled device is included in the user's buddy list, the user can know whether the real-time communication protocol enabled device is available to be used. As described below, the present invention provides the capability for connecting and communication with non-RTC enabled devices.

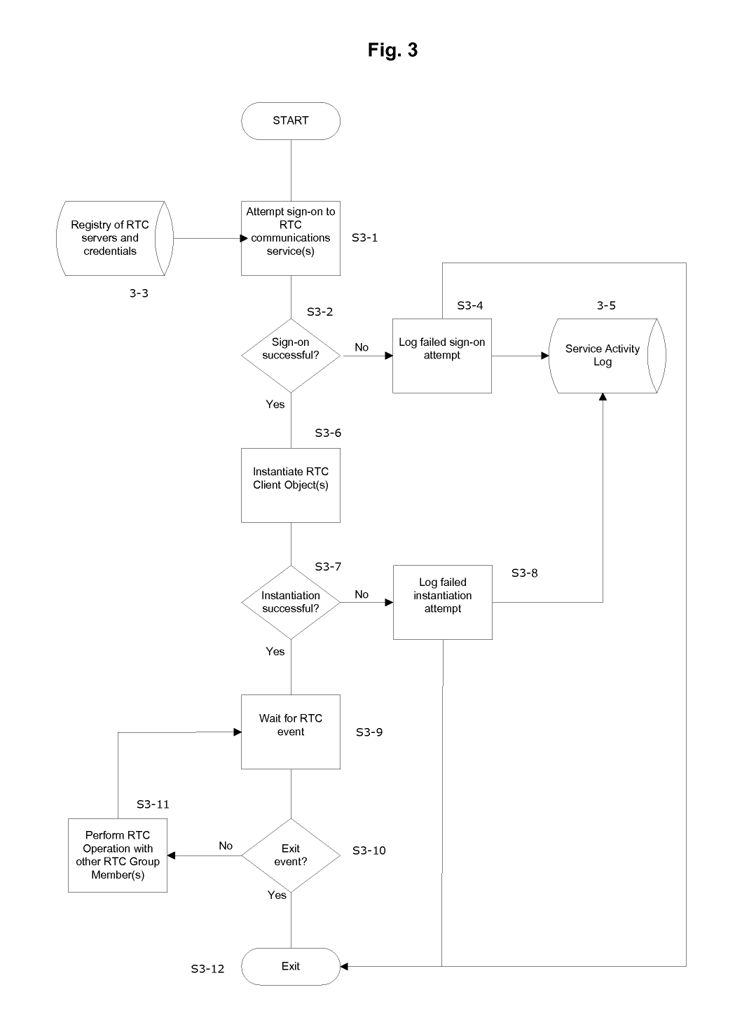

Returning to FIG. 1, Public RTC Server 11 is used to establish connection and allow communication between users and real-time communication protocol enabled devices on home network 68 with the real-time communication protocol enabled devices on network 10. The connection is only available for those users and devices that are registered with Public RTC Server 11. The method of registering is described below with respect to FIG. 3.

RTC Development/Workgroup Server 10.2.1.2 is used to establish connection and allow communication between users and real-time communication protocol enabled devices on network 10. The connection is only available for those users and devices on network 10 that have registered with the RTC Development/Workgroup Server 10.2.1.2. The method of registering is described below with respect to FIG. 3.

RTC Maintenance Server 10.2.1.3 is also used to establish connection and allow communication between users and real-time communication protocol enabled devices on network 10. The connection is only available for those users and devices on network 10 that have registered with the RTC Maintenance Server 10.2.1.3. In this case, only those users authorized to perform a maintenance operation and those real-time communication protocol enabled devices that a maintenance operation is allowed to be performed on are registered with the RTC Maintenance Server 10.2.1.3.

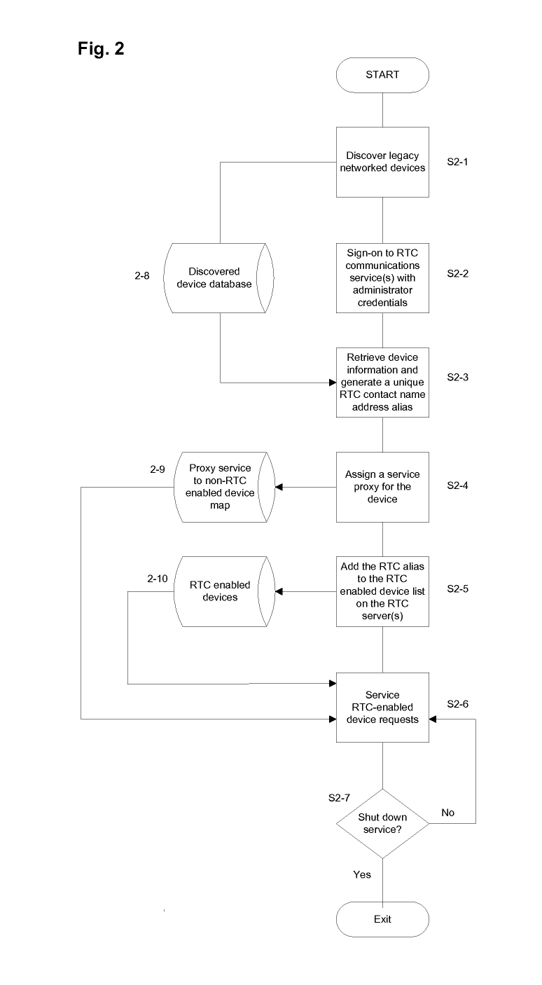

FIG. 2 is a flowchart describing the process of allowing non-real time communication protocol enabled devices to participate in real-time communication protocol scenarios. Briefly, the process includes discovering non-real time communication protocol enabled devices, logging onto at least one real-time communication server, retrieving information associated with at least one of the discovered devices, assigning a unique real-time communication protocol identity to at least one of the non-real time communication protocol enabled devices, assigning a proxy service for the non-real time communication protocol enabled device, and adding the real-time communication protocol identity to the real-time communication server.

In more detail, in step S2-1, a discovery process is initiated to discover non-real time communication protocol enabled (legacy) devices that are part of a network, i.e., system 1. Any known method for discovering devices on a network is applicable. For example, devices can be discovered by looking a device up in a directory service, or by passively observing network traffic to determine the devices that no real-time communication protocol traffic are being sent to. These are just two examples of how non-real time communication enabled devices can be discovered, and the present invention is not limited to these examples. Any method of device discovery that would enable practice of the present invention is applicable. The discovered devices are added to discovered devices database 2-8.

Next, in step S2-2, the user logs on to a real-time communications service server. The log on is made using administrator credentials, i.e., administrator user name and password information. Then, in step S2-3, device information for the non-real time communication protocol enabled devices discovered in step S2-1 is retrieved from the discovered devices database 2-8. In addition, a real-time communications contact name address alias (i.e., instant messaging identity) is created for the non-real time communications protocol enabled devices based on the device's corresponding retrieved device information. For example, the real-time communications alias is based on unique device qualities and identifiers such as media access control (MAC) address, serial number, etc. where the alias can have the following form:

“printerC803EFAB3BA @rtcserver.com”

Flow then proceeds to step S2-4, where a proxy service for the non-real time communication protocol enabled devices is assigned for each device. Assignment of a proxy service is based in part on the device type and accessible capabilities of the device. For example, if the device is a printer, whether the printer is capable of performing generic printing functions (e.g., black/white printing, multiple pages, etc.) or whether the printer is capable of performing complex printing functions (e.g., color printing, double-sided printing, etc.). The assigned proxy service is then stored in relationship to the non-real time communication protocol enabled device in the proxy service to non-RTC enabled device map 2-9.

In step S2-5, the real-time communication alias is added to the real-time communication protocol enabled device list 2-10 on the real-time communication server. Then, in step S2-6, any services requested of the device with corresponding real-time communication aliases are performed by handing off the requests to the appropriate proxy service and then returning the results to the service requestor. In step S2-7, a check is made whether there are any additional requests to be serviced. If there are none, then the service is shut-down.

FIG. 3 is a flowchart describing a user's process of using a non-real-time communication enabled protocol device that has been enabled to participate in real-time communication scenarios per the process of FIG. 2 described above. First, in step S3-1, a user attempts to log/sign onto a real-time communications service server. Logging in/signing onto a real-time communications service server typically consists of the user providing previously established membership credentials, where these credentials are typically a user name and password. The registry of real-time communications servers and credentials (3-3) contains the server address information and credentials for logging/signing onto the real-time communications service servers of which the user is a member.

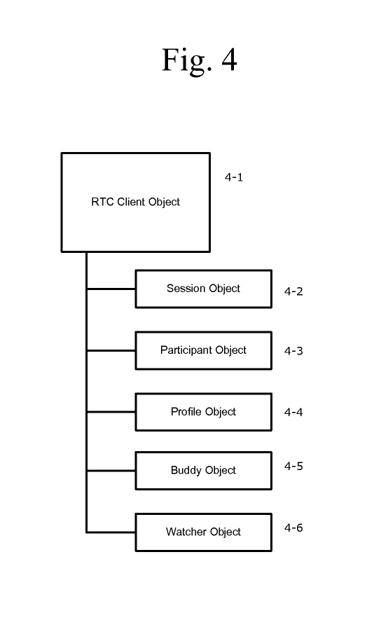

Next, in step S3-2, a determination is made whether the user successfully logged onto the real-time communication server. This determination is typically performed by comparing the credentials provided in step S3-1 with those stored in the registry of real-time communication servers and credentials 3-3. If the log/sign on fails, flow proceeds to step S3-4, where the failed log/sign on attempt is logged in the service activity log (3-5). If the user successfully logs/signs onto the real-time communications service, flow proceeds to step S3-6, where the real-time communications client objects and sub-objects, as described in FIG. 4 below, are instantiated and prepared on for example, user devices 68c, 10.13.1.4, and 10.14.1.4 to process requests.

FIG. 4 depicts the architecture of the RTC client as it appears on user devices 68c, 10.13.1.4, and 10.14.1.4. In more detail, RTC Client Object 4-1 contains the overall bookkeeping information for the real-time communication service client (i.e., user device) and the other objects, including the following described objects. Session Object 4-2 manages the real-time information communication service session, including session initiation, answering, terminating, and adding participants, etc. Participant Object 4-3 manages/contains a session participant, including participant state information, name, etc. Profile Object 4-4 contains the bookkeeping information for the client (i.e., user device) and manages such information as display name, user name, supported session types, network resources, and accounts, etc. Buddy Object 4-5 manages contact information and status. Watcher Object 4-6 manages information about the state of a “watcher”, i.e., entities that have added this object as a contact.

Returning to FIG. 3, after the RTC client object 4-1 and all sub-objects (4-2 through 4-6) are instantiated in step S3-6, in step S3-7, it is determined whether the instantiation was successful. If the instantiation fails, flow proceeds to step S3-8, where the failed instantiation attempt is logged in the service activity log (3-5). If the instantiation is successful, flow proceeds to step S3-9, where the process waits for an RTC event. RTC events include, among other things, an indication from a member of the user's buddy list that the member is available for establishing a real-time communication session.

In step S3-10, a check is performed whether to exit the event that occurred in step S3-9. If the event is not to be exited, flow proceeds to step S3-11, where a real-time communication operation is performed either with a real-time communication protocol service group members, i.e., a member on the user's buddy list. For example, a user selects “home inkjet printer” 68p from the user's buddy list on network computer 10.13.1.4 and proceeds to print a digital image from network computer 10.13.1.4 on “home inkjet printer” 68p. In another example, a user selects “home inkjet printer” 68p from the user's buddy list displayed on the user's camera enabled cellular phone (not shown) and then proceeds to print a digital image from the camera on “home inkjet printer” 68p. Other operations can include faxing, scanning, or data storage. Non-real time communication enabled devices are included in the real time communication protocol service group members as described above.

Upon completion of all activities associated with a particular real-time communication server, i.e., retrieving real-time communication protocol enabled device information and/or initiating an operation with a real-time communication protocol enabled device, flow proceeds to step S3-12, where the process ends, i.e., the user exits the real-time communication service.

In another embodiment, the operation performed in step S3-11 can be restricted. For example, operational restrictions can be used to limit the number of pages that can be printed at a particular printer, limit the amount of data that can be stored at particular storage location, etc. Other types of operational limitations can include access count, time-of-day, or any other operational restriction that would enable practice of the present invention. In the case of real-time communication protocol enabled devices, these restrictions can be set based on the type of device and capabilities of the device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A method for allowing non-real time communication protocol enabled devices to participate in real-time communication protocol scenarios, comprising:
discovering at least one non-real time communication protocol enabled device;
logging on to at least one real-time communication server;
assigning a unique real-time communication protocol identity to the at least one non-real time communication protocol enabled device;
assigning a service proxy for the at least one non-real time communication protocol enabled device; and
adding the unique real-time communication protocol identity to the at least one real-time communication server.

2. A method according to claim 1, wherein assignment of the unique real-time communication protocol identity includes retrieving information about the at least one non-real time communication protocol enabled device.

3. A method according to claim 2, wherein the retrieved information includes the at least one non-real time communication protocol enabled device's media access control (MAC) address or serial number.

4. A method according to claim 1, wherein the assigned unique real-time communication protocol identity is a real-time communication protocol contact name.

5. A method according to claim 1, wherein assignment of the service proxy is based in part on the device type and capabilities of the non-real time communication protocol enabled device.

6. A method according to claim 1, wherein the addition of the unique real-time communication protocol identity is accomplished using the real-time communication server's administrative interface.

7. A method according to claim 1, further comprising performing requested services directed towards the at least on non-real time communication protocol enabled device via the assigned service proxy.

8. A method according to claim 7, wherein the requested services include printing, faxing, scanning, and data storage requests.

9. A system for allowing non-real time communication protocol enabled devices to participate in real-time communication protocol scenarios, comprising:
a discovering unit for discovering at least one non-real time communication protocol enabled device;
a logging unit for logging on to at least one real-time communication server;
an assigning unit for assigning a unique real-time communication protocol identity to the at least one non-real time communication protocol enabled device;
an assigning unit for assigning a service proxy for the at least one non-real time communication protocol enabled device; and
an adding unit for adding the unique real-time communication protocol identity to the at least one real-time communication server.

10. A system according to claim 9, wherein assignment of the unique real-time communication protocol identity includes retrieving information about the at least one non-real time communication protocol enabled device.

11. A system according to claim 10, wherein the retrieved information includes the at least one non-real time communication protocol enabled device's media access control (MAC) address or serial number.

12. A system according to claim 9, wherein the assigned unique real-time communication protocol identity is a real-time communication protocol contact name.

13. A system according to claim 9, wherein assignment of the service proxy is based in part on the device type and capabilities of the non-real time communication protocol enabled device.

14. A system according to claim 9, wherein the addition of the unique real-time communication protocol identity is accomplished using the real-time communication server's administrative interface.

15. A system according to claim 9, further comprising performing requested services directed towards the at least on non-real time communication protocol enabled device via the assigned service proxy.

16. A system according to claim 15, wherein the requested services include printing, faxing, scanning, and data storage requests.

17. Computer-executable process steps for enabling non-real time communication protocol enabled devices to participate in real-time communication protocol scenarios, the process steps comprising:
discovering at least one non-real time communication protocol enabled device;
logging on to at least one real-time communication server;
assigning a unique real-time communication protocol identity to the at least one non-real time communication protocol enabled device;
assigning a service proxy for the at least one non-real time communication protocol enabled device; and
adding the unique real-time communication protocol identity to the at least one real-time communication server.

18. Computer-executable process steps according to claim 17, wherein the assigned real-time communication protocol identity is a real-time communication protocol contact name.

19. Computer-executable process steps according to claim 17, wherein assignment of the service proxy is based in part on the device type and capabilities of the non-real time communication protocol enabled device.

20. Computer readable storage medium storing computer-executable process steps for enabling non-real time communication protocol enabled devices to participate in real-time communication protocol scenarios, the process steps comprising:
discovering at least one non-real time communication protocol enabled device;
logging on to at least one real-time communication server;
assigning a unique real-time communication protocol identity to the at least one non-real time communication protocol enabled device;
assigning a service proxy for the at least one non-real time communication protocol enabled device; and
adding the unique real-time communication protocol identity to the at least one real-time communication server.
